(19) United States
(12) Patent Application Publication
(10) Pub. No.: US 2026/0279035 A1
(43) Pub. Date: Sep. 17, 2026

(54) MACHINE LEARNING SYSTEM

(71) Applicant: Hitachi High-Tech Corporation, Tokyo (JP)

(72) Inventors: Masayoshi ISHIKAWA, Tokyo (JP); Goshi SASAKI, Tokyo (JP); Daisuke ASAI, Tokyo (JP); Yuichi ABE, Tokyo (JP); Yohei MINEKAWA, Tokyo (JP); Mitsuji IKEDA, Tokyo (JP)

(21) Appl. No.: 19/119,129

(22) PCT Filed: Nov. 1, 2023
(86) PCT No.: PCT/JP2023/039445

§ 371 Date: Apr. 8, 2025

(30) Foreign Application Priority Data
Dec. 23, 2022 (JP) 2022-206316

(51) Int. Cl. G06V 10/82; G06T 7/11; G06V 10/26

(52) U.S. Cl. CPC G06V 10/82; G06T 7/11; G06V 10/26

(57) ABSTRACT

A machine learning system that evaluates reliability of a prediction result of a machine learning model includes: a machine learning model configured to execute a predetermined task on input data to extract an image feature value from a prediction result and the input data to generate a feature extraction result; a label generation unit configured to segment the feature extraction result into a plurality of segmented regions based on similarity of the image feature value of the input data to generate a generated label; and a determination unit configured to evaluate the machine learning model based on an overlap degree between the prediction result and the generated label. A label generation unit is configured to divide data input into a machine learning model for each neighboring region having a similar feature value and output a generated label.

### TECHNICAL FIELD

The present invention relates to a so-called machine learning.

### BACKGROUND ART

Nowadays, machine learning using a machine learning model has been used in various fields. In machine learning, it is important to evaluate the reliability of a prediction result of a machine learning model in order to support training, management, and operation of the machine learning model. For example, PTL 1 discloses that accuracy degradation is detected by comparing an output of a machine learning model with an output of a different model in order to monitor the accuracy of the machine learning model.

### CITATION LIST

### Patent Literature

PTL 1: WO2021/079478

### SUMMARY OF INVENTION

### Technical Problem

PTL 1 discloses a method of comparing an output of a machine learning model with an output of a model for detecting accuracy degradation, and detecting accuracy degradation when the outputs do not match. However, particularly when the technique is applied to image processing such as segmentation, many regions near a boundary of a recognition object where the output of the machine learning model is likely to be unstable are detected. Therefore, it is difficult to adjust the accuracy degradation detection sensitivity. In addition, since detection is likely to occur near the boundary of the recognition object, if the detection sensitivity is lowered in order to restrict erroneous detection, erroneous recognition of a central portion of the recognition object is missed. Therefore, an object of the invention is to reduce the influence of a decrease in reliability in the vicinity of a recognition object boundary in a task such as segmentation that is more advanced than image classification, and to determine a region with more significant low reliability.

### Solution to Problem

A configuration of the invention for solving the above problem is a machine learning system that evaluates reliability of a prediction result of a machine learning model, the machine learning system including: a machine learning model configured to execute a predetermined task on input data to extract an image feature value from a prediction result and the input data to generate a feature extraction result; a label generation unit configured to segment the feature extraction result into a plurality of segmented regions based on similarity of the image feature value of the input data to generate a generated label; and a determination unit configured to evaluate the machine learning model based on an overlap degree between the prediction result and the generation label.

### Advantageous Effects of Invention

According to the invention, it is possible to stably evaluate reliability even in a machine learning model that executes a task such as advanced image processing like segmentation. Problems, configurations, and effects other than those described above will be clarified by the following description of embodiments.

### BRIEF DESCRIPTION OF DRAWINGS

FIG. 1 is a diagram illustrating an outline of evaluation of a machine learning model using a machine learning system 100 according to an embodiment of the invention.

FIG. 2 is a functional block diagram of the machine learning system 100 according to Embodiment 1.

FIG. 3 is a flowchart illustrating a processing flow according to Embodiment 1.

FIG. 4 is a functional block diagram of a label generation unit 203 according to Embodiment 1.

FIG. 5 is a diagram schematically illustrating processing in the label generation unit 203 according to Embodiment 1.

FIG. 6 is a flowchart illustrating a processing flow by the label generation unit 203 according to Embodiment 1.

FIG. 7 is a configuration diagram of a neural network used in unsupervised image segmentation in Embodiment 1.

FIG. 8 is a functional block diagram of the machine learning system 100 according to Embodiment 2.

FIG. 9 is a diagram illustrating a screen example of a teaching unit 803 according to Embodiment 2.

FIG. 10 is a flowchart illustrating a processing flow according to Embodiment 3.

FIG. 11 is a diagram illustrating an implementation example of the machine learning system 100 according to Embodiment 5.

### DESCRIPTION OF EMBODIMENTS

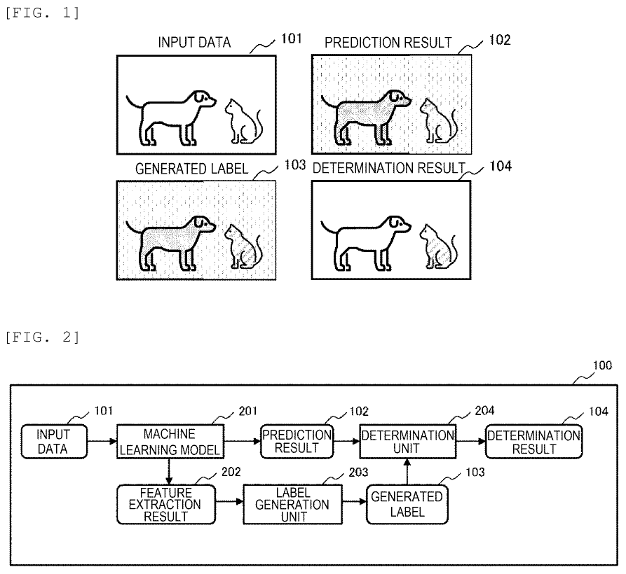

Hereinafter, embodiments of the invention will be described with reference to the drawings. FIG. 1 is a diagram illustrating an outline of evaluation of a machine learning model using a machine learning system 100 according to the embodiment. In FIG. 1, image data is an object. Hereinafter, an outline of processing of the machine learning system 100 will be described. The machine learning system 100 first inputs input data 101 to the machine learning model to obtain a prediction result 102. The machine learning system 100 compares the obtained prediction result 102 with a generated label 103. Then, the machine learning system 100 outputs a comparison result as an evaluation result of 41 the machine learning model. For example, the machine learning system 100 outputs, as a determination result 104, a region that is determined to have low reliability as the evaluation result.

Here, the machine learning model in the embodiment is assumed to be a segmentation model. Therefore, the embodiment can be used for various segmentation models such as semantic segmentation, instance segmentation, and panoptic segmentation.

The above-described prediction result 102 is the prediction result 102 obtained by inputting the input data 101 to the machine learning model. Therefore, in FIG. 1, in the prediction result 102, predicted classes are indicated with different textures for the input data 101 that is image data. This class is s information in which a class number or the like is added to a segmented region into which a shape of a dog or the like shown in the drawing is segmented.

FIG. 1 illustrates an example in which each pixel in the image data is predicted to be any class of a background, a dog, and a cat as the prediction result 102. FIG. 1 illustrates an example in which the class of the dog is correctly predicted, but the class of the cat is erroneously classified into the background class by erroneously classifying the body portion. That is, in the drawing, the head of the cat is indicated by a hatched texture, and a body portion thereof is indicated by a texture of a vertical broken line similarly to the background. In this example, the body portion of the cat should also be predicted as the class of the cat. For this reason, in the embodiment, an object is to determine such an erroneously classified region as a region with low reliability of the prediction result.

Therefore, in order to achieve this object, the generated label 103 is generated in the embodiment. The generated label 103 is generated by segmenting a feature extraction result 202, which is image data, into a plurality of segmented regions. As for the segmented region, the feature extraction result 202 can be divided into a plurality of divided regions based on an image feature value, and the divided regions can be integrated to generate the segmented region. As a result, the feature extraction result 202 is segmented by the segmented region. That is, in the embodiment, the segmented region is specified based on the divided region. The specification of the segmented regions includes integration of the divided regions and diversion thereof. Furthermore, the generation of the generated label 103 may be performed by a method different from the generation of the prediction result 102, and is not limited to the above-described method.

The segmented regions in the generated label 103 generated in this manner are assumed to belong to the same predicted class. In FIG. 1, image coordinates in the same segmented region are indicated by the same texture (the above-described diagonal lines or vertical broken lines). The divided region or the segmented region is preferably a region including at least one unit region such as a pixel.

The machine learning system 100 according to the embodiment compares the prediction result 102 with the generated label 103, and evaluates the machine learning model for predicting the prediction result 102. More specifically, the machine learning system 100 outputs, as the determination result 104, a region for which the prediction result 102 and a division result of the generated label 103 do not match. That is, the machine learning system 100 outputs a region, which belongs to different textures in the prediction result 102 and the generated label 103, as the determination result 104 as indicated by hatching in the determination result 104. By performing such processing, it is possible to reduce the influence of the reliability of the machine learning model that decreases in the vicinity of a recognition object boundary in the image data, and to easily specify a region to be confirmed with lower reliability. Although image data is set as an object in the embodiment, the invention may be applied to other types of data. Hereinafter, embodiments showing more specific aspects of the embodiment will be described.

### Embodiment 1

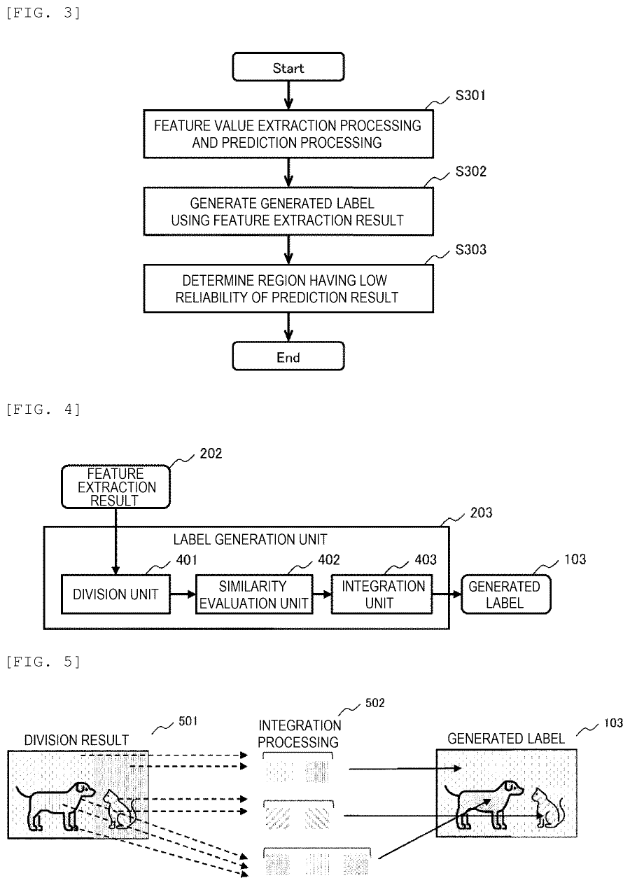

FIG. 2 is a functional block diagram of the machine learning system 100 according to Embodiment 1. In FIG. 2, the machine learning system 100 includes a machine learning model 201, a label generation unit 203, and a determination unit 204. Here, the machine learning model 201 performs prediction processing on the input data 101 according to a training result, and outputs the prediction result 102. The machine learning model 201 extracts a feature value, that is, the feature extraction result 202 from the input data 101. In the embodiment, an image feature value is used as the feature extraction result 202. In this way, the machine learning model 201 functions as a processing unit that performs learning and executes a predetermined task.

The label generation unit 203 generates the generated label 103 from the feature extraction result 202.

Then, the determination unit 204 compares the prediction result 102 and the generated label 103, and determines a region for which the divisions do not match. More specifically, the determination unit 204 sets a region, for which the divisions do not match, as the determination result 104 and outputs the determination result 104. It is desirable that the machine learning system 100 further includes an input unit that receives the input data 101 and a user operation and an output unit that outputs the determination result 104 to the outside.

Next, a processing flow according to Embodiment 1 will be described. FIG. 3 is a flowchart illustrating the processing flow according to Embodiment 1.

First, in step S301, the machine learning model 201 executes feature value extraction processing and prediction processing on the input data 101 that is image data. For this purpose, first, the machine learning model 201 receives the input data 101. The machine learning model 201 extracts the feature extraction result 202, which is an image feature value, from the received input data 101. In addition, the machine learning model 201 performs the prediction processing on the received input data 101 and predicts the prediction result 102.

Here, the feature extraction result 202 indicates an image feature value extracted by the machine learning model 201 to output the prediction result 102. That is, the machine learning model 201 extracts image feature values at respective image coordinates of the input data 101 that is image data. For example, when the machine learning model 201 is a neural network, the machine learning model 201 extracts the feature extraction result 202 by using a feature value map that is a third-order tensor obtained in an intermediate layer. At this time, as the feature value map, an output of a single intermediate layer may be used, or outputs of a plurality of intermediate layers may be used in combination. Further, the prediction result 102 is information indicating a result of executing a task such as a cutout result of a class of an object or the like with respect to the input data 101. The image coordinates in the embodiment include not only image coordinates in a narrow sense as coordinates in image data but also other position information and unit regions such as pixels.

In step S302, the label generation unit 203 generates the generated label 103 from the feature extraction result 202. For this purpose, the label generation unit 203 generates the generated label 103 from the feature extraction result 202 by using the similarity of image feature values in the feature extraction result 202.

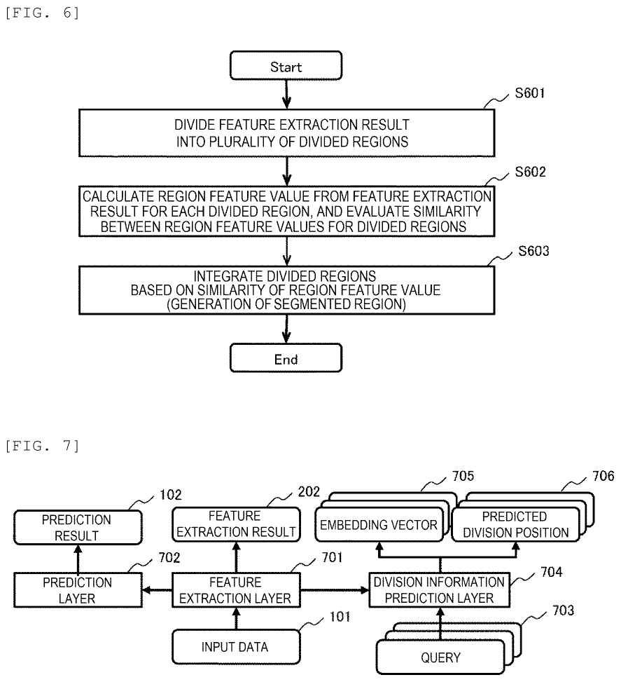

More desirably, the label generation unit 203 generates the generated label 103 by dividing the feature extraction result 202 into divided regions and integrating the divided regions to generate a segmented region. Details of the generation processing will be described later with reference to FIGS. 4 to 6.

In step S303, the determination unit 204 determines a region with low reliability in the prediction result 102 for evaluation of the machine learning model 201. For this purpose, the determination unit 204 compares the prediction result 102 and the generated label 103, and determines a region that belongs to different segmented regions.

Here, the “region that belongs to different segmented regions” corresponds to a hatched portion (head of the cat) in the determination result 104 in FIG. 1. In this way, the determination unit 204 specifies the determination result 104. Desirably, the determination unit 204 outputs the determination result 104.

Here, the segmented region indicated by the generated label 103 does not have class information, and a only has information indicating to which segmented region the image coordinates belong. Therefore, for example, a comparison cannot be simply performed using a value such as a class number. The region with low reliability is a region with a low overlap degree. The “low” in the terms can be determined to be equal to or less than a predetermined threshold or to be relatively low in each region (for example, several ranks lower).

Therefore, the determination unit 204 performs matching between the predicted class of the prediction result 102 and the segmented region of the generated label 103 such that a region overlapping area increases, and specifies the predicted class to which each segmented region should belong. Then, the determination unit 204 determines a region, for which the predicted class to which each segmented region should belong does not match the prediction result 102, as a region with low reliability.

The calculation of the region overlapping area can be realized using an index called Intersection over union or Dice Similarity. Therefore, the determination unit 204 evaluates an overlap degree between combinations of the segmented regions of the prediction result 102 and the segmented regions of the generated label 103. The content will be described with reference to FIG. 1.

First, the determination unit 204 evaluates, using the above-described index, an overlap degree between predicted classes (or segmented regions corresponding thereto) of the background, the cat, and the dog in the prediction result 102 and three segmented regions in the generated label 103. Thereafter, the determination unit 204 determines, by matching, a combination of a class and a segmented region for which the overlap degree is large. That is, the class and segmented region of the background and the class and segmented region of the dog in the prediction result 102 and the generated label 103 are allocated by matching. The class of the head of the cat in the prediction result 102 is allocated to the segmented region of the entire cat in the generated label 103.

As a result, the determination unit 204 specifies the predicted class to which each segmented region should belong. For example, the determination unit 204 evaluates, for each combination of segmented regions, a region having belonging segmented regions that do not match, an area thereof, or the like. That is, when the area that does not match is equal to or greater than a threshold, the determination unit 204 determines that the region is a region with low reliability.

Here, an example of semantic segmentation is described. However, in the case of instance segmentation or panoptic segmentation, matching may be performed using an instance number instead of a predicted class. In this case, the determination unit 204 determines a region, for which the instance number to which each segmented region should belong does not match the prediction result 102, as a region with low reliability.

The determination unit 204 may make the following changes in order to reduce erroneous determination. For example, (1) the vicinity of a region boundary of the prediction result 102 or the generated label 103 is excluded from a determination object, and (2) a class for which allocation is prioritized is designated in the prediction result 102. Such changes make it possible to obtain the determination result 104 that is easy for an operator of the machine learning system 100 to use.

By performing the above processing, it is possible to accurately determine a region with low reliability of the prediction result 102 even if a true value of the input data 101 is unknown in a task such as segmentation in which the reliability is likely to decrease in the vicinity of a recognition object boundary. In the processing, it is important to generate the generated label 103 with high accuracy by the label generation unit 203.

As described above, the label generation unit 203 according to the embodiment generates the generated label 103 by dividing the input data 101 into a plurality of divided regions based on the feature extraction result 202 and integrating divided regions having similar image feature values to generate the segmented regions.

Here, details of the label generation unit 203 that performs such generation processing will be described. FIG. 4 is a functional block diagram of the label generation unit 203 according to Embodiment 1. In FIG. 4, the label generation unit 203 includes a division unit 401, a similarity evaluation unit 402, and an integration unit 403. Here, the division unit 401 divides the feature extraction result 202, which is image data, into divided regions. The similarity evaluation unit 402 calculates region feature values indicating features of the divided regions by using image feature values, and evaluates similarity thereof. In addition, the integration unit 403 integrates similar divided regions based on the similarity to generate a segmented region.

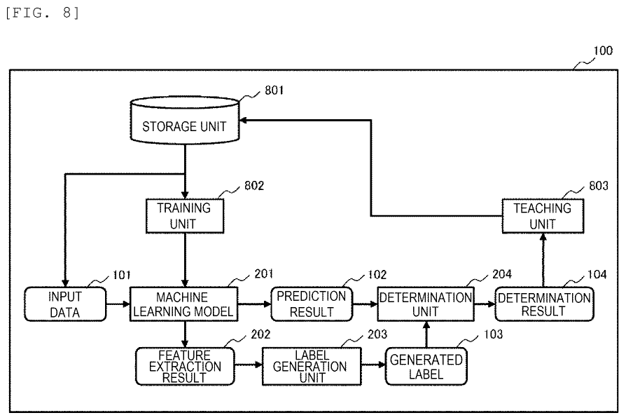

Next, a processing flow of the label generation unit 203 will be described with reference to FIG. 5 using a flowchart in FIG. 6. FIG. 5 is a diagram schematically illustrating processing in the label generation unit 203 according to Embodiment 1. FIG. 6 is a flowchart illustrating a processing flow in the label generation unit 203 according to Embodiment 1.

First, in step S601 in FIG. 6, the division unit 401 divides the feature extraction result 202 into divided regions to obtain a division result 501 illustrated in FIG. 5. As indicated by the division result 501, this division is executed so that the feature extraction result 202 is constituted by image coordinates that are close on an image coordinate system and have similar feature values. The division result 501 in FIG. 5 illustrates an example in which the background is divided into two divided regions on the left side and the right side, the dog is divided into three divided regions of the head, the body, and legs, and the cat is divided into two divided regions of the head and the body.

For this purpose, the division unit 401 compares the image feature values of the image coordinates in the feature extraction result 202. As a result of the comparison, the division unit 401 specifies neighboring regions that are configured with neighboring image coordinates and have similar feature extraction results 202. Then, the division unit 401 sets the specified neighboring region as a divided region. The similarity means that a difference between the image feature values satisfies a predetermined requirement such as being within a predetermined range.

In step S602, the similarity evaluation unit 402 calculates a region feature value from the feature extraction result 202 for each divided region divided by the division unit 401, and evaluates similarity between the region feature values of the respective divided regions. Here, the region feature value is a value calculated from the image feature value at the image coordinates belonging to the divided region. For example, in a case where the feature extraction result 202 is a feature value map represented by a third-order tensor, since the feature extraction result 202 has different feature values for respective image coordinates, an average value, a median value, or the like of the feature values at the image coordinates belonging to each divided region can be used. The similarity evaluation unit 402 evaluates the similarity between the region feature values obtained for each divided region. At this time, the similarity evaluation unit 402 desirably evaluates the similarity between adjacent divided regions. Therefore, for example, the similarity evaluation unit 402 calculates the similarity between the region feature values. The similarity evaluation unit 402 determines whether the similarity is within a predetermined range, that is, whether the divided regions for which the similarity is calculated are similar to each other. Here, the similarity is a value indicating similarity between region feature values such as a square error and cosine similarity.

In step S603, the integration unit 403 integrates the divided regions based on the similarity of the region feature values to generate a segmented region. Here, the content will be described with reference to FIG. 5. In FIG. 5, each texture in the division result 501 indicates a region feature value for each divided region. Here, image coordinates belonging to the same class or instance in the input data 101 have a feature value of similarity. Therefore, the integration unit 403 can generate the generated label 103 including segmented regions that should have the same prediction value by integrating divided regions having similar region feature values. In this step, when there are no similar regions among adjacent divided regions, a divided region as an object becomes the segmented region as it is.

Furthermore, in step S603, the integration unit 403 may integrate the divided regions within a predetermined restriction range. As the restriction, the number of times of integration, the number of segmented regions, the area thereof, and the like stored in advance can be used. When the number of times of integration is used, the integration is performed within the number of times. Regarding the number of segmented regions, the integration is performed such that the number is not a certain number or less. Further, regarding the area of the segmented region, the integration is performed such that the area of the largest segmented region is not within a predetermined magnitude.

By the above processing, the label generation unit 203 generates the generated label 103 including a plurality of segmented regions configured with image coordinates having similar image feature values. Accordingly, it is possible to reduce the influence of the vicinity of a boundary of a recognition object and specify a divided region whose reliability is significantly reduced in the prediction result. The similarity means that a difference between the image feature values satisfies a predetermined requirement such as being within a predetermined range.

In step S602, the similarity may be determined by the same method as in step S601. Further, in step S601, the similarity may be determined by the same method as in step S602. As described above, in this processing flow, the label generation unit 203 generates the generated label 103 from the feature extraction result 202 based on the similarity of the image feature.

In the embodiment, a method is described in which the division unit 401 divides the feature extraction result 202 into the divided regions and integrates divided regions having similar feature values. However, the similarity evaluation unit 402, the integration unit 403, or the processing thereof may be omitted, and a processing result of the division unit 401 may be used as the generated label 103.

That is, the divided region of the division unit 401 can be used as the segmented region.

The integration unit 403 may use the prediction result 102 such that the granularity of division in the generated label 103 generated by the label generation unit 203 is substantially the same as that of the prediction result 102. In this case, the integration unit 403 performs integration processing on regions integrated into the same divided region in the generated label 103 to increase the overlap degree with the region of the prediction result 102.

The integration unit 403 may use a parameter for controlling integration processing. That is, a threshold for the similarity for performing integration determination, conditional branching for controlling integration availability depending on whether regions are adjacent to each other, or a restriction on the area of a region after integration may be imposed.

These parameters may be separated according to whether a target task is semantic segmentation or instance segmentation.

The similarity evaluation of the similarity evaluation unit 402 and the integration processing of the integration unit 403 may be performed together by a method such as clustering. The division of the feature extraction result 202 into the divided regions performed by the division unit 401 may use, for example, an image division method called super pixel or an unsupervised image division method using a neural network described in the embodiment.

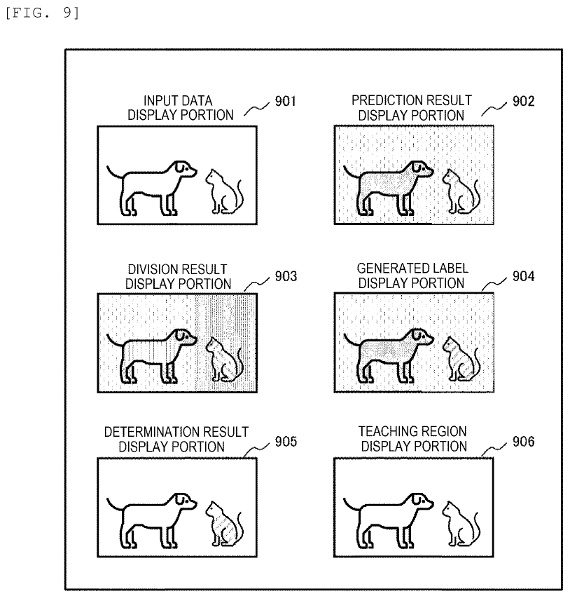

Here, FIG. 7 is a configuration diagram of a neural network used in unsupervised image division in Embodiment 1. The neural network used in the embodiment extracts an image feature value from the input data 101 by a feature extraction layer 701 and uses the image feature value for various types of processing. That is, the output of the feature extraction layer 701 is the feature extraction result 202.

A prediction layer 702 of the neural network generates and outputs the prediction result 102 by using the feature value extracted by the feature extraction layer 701. A division information prediction layer 704 of the neural network generates and outputs an embedding vector 705 and a predicted division position 706 by using the feature value extracted by the feature extraction layer 701 and a query 703. Here, the query 703 is a parameter of the neural network, and is a plurality of vectors updated by training.

The division information prediction layer 704 generates and outputs the embedding vector 705 and the predicted division position 706 by updating the query 703 using the image feature value extracted by the feature extraction layer. Here, the same number of embedding vectors 705 and predicted division positions 706 as the number of queries in the neural network are output. The division information prediction layer 704 has a configuration called, for example, a caution mechanism, dynamically determines a region of interest on a feature value map obtained by the feature extraction layer 701 for each of a plurality of queries, and aggregates information, thereby obtaining a feature necessary for region division.

When the division unit 401 performs division, the feature extraction result 202 and the embedding vector 705 are used to specify the embedding vector 705 having similar image coordinates of the feature extraction result 202, and division into different divided regions is performed for each similar embedding vector 705. For example, when the neural network has three queries, three embedding vectors 705 are also output, and the image data is divided into up to three divided regions by obtaining a similar embedding vector 705 for each image coordinate of the feature extraction result 202.

In the embodiment, division processing by the neural network that performs such a behavior is trained by unsupervised learning that does not require annotation. The content will be described below. In this case, pseudo image division is performed to generate pseudo divided regions. This is achieved by training the neural network so that the feature value of the feature extraction result 202 can be identified for each generated pseudo divided region.

Here, the feature extraction result 202, the embedding vector 705, and the predicted division position 706 are used to generate the pseudo divided region. First, the feature extraction result 202 is set as a single feature value map M□R\hat{ }H×W×C, the embedding vector 705 is represented by E□R\hat{ }Q×C, and the predicted division position 706 is represented by P□R\hat{ }Q×2. Here, H and W are a height and a width of the feature value map M, which is a third-order tensor, and Q is the number of queries of the neural network. The pseudo divided region can be obtained from these tensors by an optimal transportation algorithm called Sinkhorn based on assignment of each coordinate of the feature value map M to a vector of the embedding vector 705. Sinkhorn is an algorithm for obtaining measures for reducing the transport cost, and here, the pseudo divided region is obtained by obtaining allocation for reducing the cost when each coordinate of the feature value map M is allocated to each of Q embedding vectors 705.

The transport cost C□R\hat{ }HW×Q of the feature value map M and the embedding vector 705 is obtained by a weighted sum of a feature value similarity cost C_f□R\hat{ }HW×Q and a division position cost C_p□R\hat{ }HW×Q.

Further, the feature value similarity cost C_f is calculated by cosine similarity, a square error, or the like with the feature value map M and the embedding vector E. Further, the division position cost C_p is obtained by calculating a square error with the predicted division position P corresponding to each embedding vector E and each coordinate of the feature value map M.

By applying Sinkhorn to the transport cost obtained here, an embedding vector number D□R\hat{ }H×W to which each coordinate of the feature value map M is allocated is determined. That is, this is represented by D=argmax Sinkhorn (C). As a result, the number of the embedding vector E allocated to each coordinate of the feature value map M is held as the embedding vector number D.

According to the transport cost C, it is possible to hold an image feature value similar to an i-th embedding vector E_i by the feature value similarity cost C_f, and obtain both the predicted division position P_i corresponding to the i-th embedding vector E_i and the image coordinates on the neighboring feature value map M by the divided position cost C_p.

In addition, the neural network learns an input data division method by training, using the obtained embedding vector number D, a predicted mask y□R\hat{ }H×W×Q obtained by, for example, cosine similarity between the feature value map M and the embedding vector E. At this time, training is performed to reduce any one or a combination of cross entropy, mask similarity loss, and the transport cost. With such a configuration, it is possible to train the neural network in an unsupervised manner using image division obtained by Sinkhorn to perform image division.

The embedding vector number D may be obtained by the neural network to be trained or may be obtained by using different neural networks having similar structures. For example, there is a method of using an exponential moving average of weights of a neural network to be trained as a parameter of a neural network having the same structure as that of the neural network to be trained.

The content described above is an example, and a layer may be added in addition to the feature extraction layer 701, the prediction layer 702, and the division information prediction layer 704. The training of the division information prediction layer 704 may be performed in advance or may be performed in parallel with the training of the prediction layer 702.

According to the embodiment, the division unit 401 divides the feature extraction result 202 into divided regions up to the number of the queries 703 by unsupervised image division. Then, the similarity evaluation unit 402 and the integration unit 403 specify the segmented region (for example, integrate the divided regions) based on the divided regions. Accordingly, it is possible to acquire the generated label 103 appropriate for the input data 101.

Although the machine learning model 201 that performs segmentation processing is set as an object in the embodiment, a machine learning model that performs object detection processing may be used. In this case, the determination unit 204 can be implemented by comparing a size of a detection window, which is the prediction result 102 of the machine learning model 201, with a size of the divided region of the generated label 103. Alternatively, an overlap degree with the detection window output by the machine learning model may be evaluated after a rectangular region surrounding divided regions of the generated label 103 is obtained.

### Embodiment 2

In Embodiment 1, the method of outputting the determination result 104 in which the reliability of the prediction result 102 of the machine learning model 201 is determined to be low in the input data 101 has been described. In Embodiment 2, a configuration in which the determination method described in Embodiment 1 is used for training of the machine learning model 201 will be described.

In the embodiment, the determination of a region with low reliability described in Embodiment 1 is performed on data to which teaching information 106 is not assigned. Then, the determination result 104 is presented to an operator together with various pieces of information to prompt the operator to assign the teaching information 106, thereby improving recognition performance of a machine learning model even with a small amount of the teaching information 106.

FIG. 8 is a functional block diagram of the machine learning system 100 according to Embodiment 2. Compared to Embodiment 1, the machine learning system 100 according to the embodiment additionally includes a storage unit 801, a training unit 802, and a teaching unit 803. The teaching unit 803 is an example of an output unit of Embodiment 1, and displays various types of information described later. The storage unit 801 stores training use data 105 (for example, image data) and the teaching information 106 that can be used for training of the machine learning model 201. Here, the teaching information 106 may not be assigned to all the data included in the storage unit 801.

The training unit 802 trains the machine learning model 201 using the training use data 105 stored in the storage unit 801. That is, the training unit 802 updates the machine learning model 201. The training is performed for a predetermined period or until the number of parameter updates of the machine learning model 201 satisfies a predetermined number of times or a predetermined end condition. Here, the training unit 802 can execute the update by using the teaching information input by the operator for a region determined to have a low overlap degree. The training unit 802 may determine necessity of the training, that is, the necessity of updating the machine learning model 201. In this case, it is desirable that the training unit 802 determines the necessity of updating the machine learning model 201 according to the region determined to have a low overlap degree.

Thereafter, the machine learning system 100 confirms the input data 101, to which the teaching information 106 is to be assigned, automatically or according to an instruction from the operator. At this time, the machine learning system 100 reads the input data 101 from the training use data 105 in the storage unit 801. Then, the determination result 104 is generated using the machine learning model 201, the label generation unit 203, and the determination unit 204.

When the determination result 104 satisfies a requirement set in advance, the input data 101 and the determination result 104 are displayed on the teaching unit 803. As a result, it is possible to prompt the operator to perform a teaching operation. Here, the requirement set in advance is a requirement such as whether the size of a region determined to have low reliability is larger than a predetermined size or whether a predicted class determined to have low reliability is included in a designated predicted class.

When the operator instructs end of the teaching operation, the machine learning system 100 stores the teaching information 106 input according to the display on the teaching unit 803 in the storage unit 801 in association with the input data 101.

According to such a configuration, even if the teaching information 106 is not assigned to all the input data 101 at the beginning, it is possible to efficiently specify the input data effective for the training of the machine learning model 201 and to complete the training with assignment of a small amount of the teaching information 106.

As the input data 101, data to which the teaching information 106 is not assigned among the training use data 105 stored in the storage unit 801 may be used, or the input data and the training use data 105 may be different data.

As the assignment of the teaching information 106 according to the display on the teaching unit 803, data to be taught may be searched asynchronously. That is, while the operator assigning the teaching information 106 according to the display on the teaching unit 803, the necessity of assigning the teaching information 106 to the other input data 101 may be determined. Further, the necessity of assigning the teaching information 106 to a plurality pieces of input data 101 is determined in advance, and the pieces of input data 101 may be presented (displayed) to the operator in order from data determined to have higher necessity of assigning the teaching information 106. A list may be presented to the operator to allow the operator to select data to be taught.

Here, display content of the teaching unit 803 will be described. FIG. 9 is a diagram illustrating a screen example of the teaching unit 803 according to Embodiment 2. As illustrated in FIG. 9, the teaching unit 803 includes an input data display portion 901, a prediction result display portion 902, a division result display portion 903, a generated label display portion 904, a determination result display portion 905, and a teaching region display portion 906. The input data display portion 901, the prediction result display portion 902, the division result display portion 903, the generated label display portion 904, and the determination result display portion 905 display the input data 101, the prediction result 102, the division result 501, the generated label 103, and the determination result 104, respectively. The teaching region display portion 906 is a region for the operator to assign the teaching information 106 to the input data 101. Here, the assignment of the teaching information 106 to the entire input data 101 may be prompted, or the assignment of the teaching information 106 may be prompted with only a periphery of a region determined to have low reliability as a region to be taught. In addition to the above, the teaching unit 803 may display a current recognition performance index value, the number of pieces of taught data, the number of pieces of untaught data, and the like.

The display content illustrated in FIG. 9 does not need to be displayed by the machine learning system 100. For example, training and detection of input data with low reliability may be performed on a server, and the teaching unit 803 may be implemented on a terminal device operated by an operator. This implementation example will be described in Embodiment 5.

### Embodiment 3

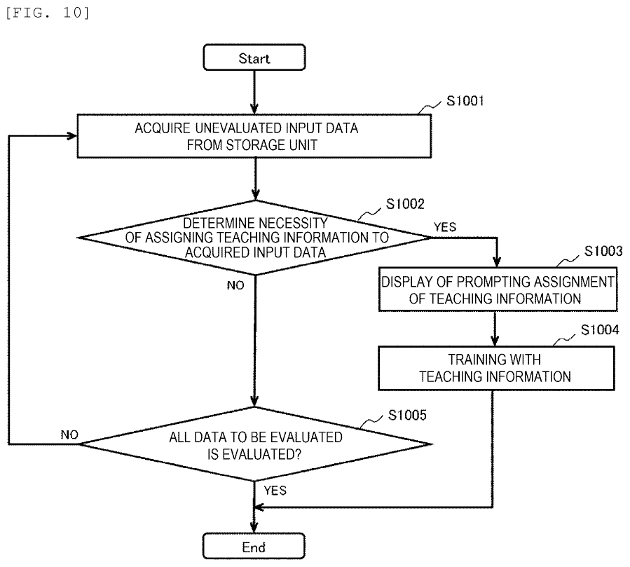

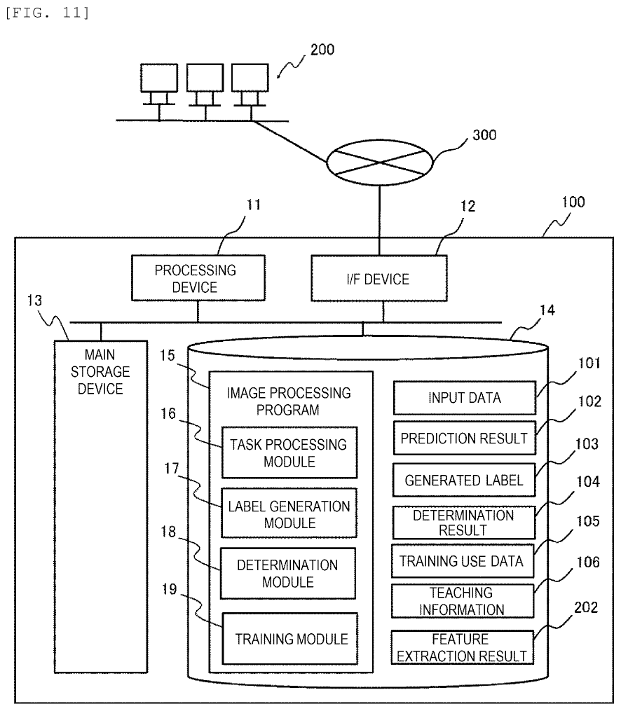

Embodiment 3 is an embodiment in which the end of training is determined using the determination method of a region with low reliability described in Embodiment 1. FIG. 10 is a flowchart illustrating a processing flow according to Embodiment 3. This flowchart is executed when the training of the machine learning model 201 by the training unit 802 satisfies an end requirement or when confirmation of the training end requirement is instructed by an operator. The configuration of Embodiment 3 is the same as that of Embodiment 2. Hereinafter, a processing flow of the embodiment will be described with reference to FIG. 10.

First, in step S1001, the machine learning model 201 acquires unevaluated input data 101 from the storage unit 801. In step S1002, the determination unit 204 acquires the determination result 104 and determines the necessity of assigning teaching information. This determination may be executed in accordance with designation from the operator with respect to the determination result 104 displayed by the teaching unit 803. As a result, if the assignment is necessary (YES), the processing proceeds to step S1003. If the assignment is not necessary (NO), the processing proceeds to step S1004.

In step S1003, the teaching unit 803 performs display for prompting the assignment of the teaching information. As a result, an input unit receives an input for teaching information assignment from the operator. In step S1004, the training unit 802 trains the machine learning model 201 using the teaching information. After the training is completed in step S1004, the flow may be ended, the processing may proceed to step S1005, or the processing flow illustrated in FIG. 10 may be performed again from the beginning.

In step S1005, the machine learning model 201 confirms whether the evaluation of this flowchart is performed on all data to be evaluated among the training use data 105 stored in the storage unit 801. If all data to be evaluated is evaluated (YES), this flowchart ends. In this case, it is desirable that the teaching unit 803 displays that the training may be ended since there is no training use data 105 that needs to be newly assigned with the teaching information. In this step, if there is unevaluated data (NO), the processing returns to step S1001.

According to Embodiment 3 described above, it is possible to evaluate whether the machine learning model 201 operates effectively even for the training use data 105 to which the teaching information is not assigned, and it is possible to support the determination of training end necessity without assigning the teaching information to more training use data 105.

### Embodiment 4

Embodiment 4 is an embodiment in which the reliability of the prediction result 102 is evaluated during the operation of the machine learning model 201 by using the determination method of a region with low reliability described in Embodiment 1. The following processing can be executed by the configuration in FIG. 2, and can also be implemented by the configuration in FIG. 8 in Embodiment 2.

When operating the machine learning model 201, if the input data 101 is not similar to learned data, the reliability of the prediction result 102 decreases. Such a situation may occur due to a change in the input data 101 to be predicted. Therefore, during operation, it is necessary to monitor the reliability of the machine learning model 201. Here, if the determination method of a region with low reliability described in Embodiment 1 is used, even in processing such as segmentation in which reliability is likely to decrease near a boundary, it is easy to detect a decrease in reliability inside a recognition object that has larger influence.

As described above, when a prediction result with low reliability is detected, an output unit may notify an operator of the prediction result and present the prediction result 102, the generated label 103, and the determination result 104 together. As a result, the operator can determine to perform retraining or the like of the machine learning model 201 based on the presented information.

A notification requirement may be set in advance. That is, the output unit may set requirements for a size of a region determined to have low reliability in the determination result 104, a predicted class determined to have low reliability, and a detection frequency, and notify the operator only when the set requirements are satisfied.

The processing of the output unit described above can also be implemented by the teaching unit 803 of Embodiment 2. Further, in the processing of the output unit (teaching unit 803), the machine learning model 201 may evaluate the reliability, and the output unit may execute the above-described processing based on a result thereof.

### Embodiment 5

Next, Embodiment 5 in which the machine learning system 100 is implemented on a server will be described. FIG. 11 is a diagram illustrating an implementation example of the machine learning system 100 according to Embodiment 5. In FIG. 11, the machine learning system 100 is connected to a terminal device group 200 via a network 300. Therefore, the machine learning system 100 can be implemented by a server also called cloud or an in-house system among computers. FIG. 11 illustrates a hardware configuration of the machine learning system 100 that is a server. That is, the machine learning system 100 includes a processing device 11, an I/F device 12 (interface device), a memory 13, and a secondary storage device 14, which are connected to each other via a communication path.

First, the processing device 11 can be implemented by a processor such as a central processing unit (CPU), and executes calculation according to an image processing program 15 stored in the secondary storage device 14 described later.

The I/F device 12 has an interface function with other devices. That is, the I/F 12 receives an input from an operator in the terminal device group 200 and outputs content to be displayed in the terminal device group 200. As described above, the terminal device group 200 and the I/F device 12 correspond to the input unit, the output unit, and the teaching unit 803 described above.

The network 300 may be a local network such as an intranet or a wide area network such as the Internet.

The memory 13 and the secondary storage device 14 correspond to the storage unit 801 described above. In the memory 13, the image processing program 15 stored in the secondary storage device 14 and information used for processing in the processing device 11 are loaded. The secondary storage device 14 can be implemented by a so-called storage. The secondary storage device 14 stores the image processing program 15, the input data 101, the prediction result 102, the generated label 103, the determination result 104, the training use data 105, the teaching information 106, and the feature extraction result 202. Some of the data and information may not be stored in the secondary storage device 14. For example, the input data 101 can be received from the terminal device group 200 via the I/F device 12.

Further, it is desirable that the secondary storage device 14 stores other information described above such as flight related information. The secondary storage device 14 may be implemented by various storage media such as an external hard disk drive (HDD), a solid state drive (SSD), and a memory card. Further, the secondary storage device 14 may be implemented by a device separate from the machine learning system 100 that is connected to the network 300, such as a file server.

Here, the image processing program 15 includes a task processing module 16, a label generation module 17, a determination module 18, and a training module 19 for respective functions.

These modules may be implemented by individual programs or a combination of some of the programs. The machine learning system 100 may be implemented by a plurality of devices for respective functions thereof. In particular, in the embodiment, training and image processing, which is a task, are implemented by one device, and can be executed by separate devices.

Configurations that are shown in FIGS. 2 and 8 and execute functions same as those of the modules are as follows.
task processing module 16: machine learning model 201 (processing unit)
label generation module 17: label generation unit 203
determination module 18: determination unit 204
training module 19: training unit 802

Therefore, the processing device 11 executes the processing described in Embodiments 1 to 4 according to the image processing program 15. The image processing program 15 can be stored in a storage medium.

The terminal device group 200 is a terminal device group operated by a user and can be implemented by a computer. The terminal device group 200 has the functions of the input unit and the output unit as described above. Although a terminal device group is used in the embodiment, a single terminal device may be used.

Although the embodiments have been described above, the invention is not limited to the above-described embodiments and includes various modifications. For example, the embodiments described above have been described in detail to facilitate understanding of the invention, and the invention is not necessarily limited to those including all the configurations described above. A part of a configuration of a certain embodiment can be replaced with a configuration of another embodiment, and the configuration of another embodiment can be added to a configuration of a certain embodiment. A part of a configuration of each embodiment may be added to, deleted from, or replaced with another configuration. That is, data serving as an object is not limited to image data, and the task is not limited to image processing. For example, voice recognition or synthesis may be performed on voice data serving as an object. In this case, a voice feature value or the like is used as the feature value. In this case, when generating the generated label 103, a degree of segmentation of a voice unit such as a word is considered.

### REFERENCE SIGNS LIST

100: machine learning system
101: input data
102: prediction result
103: generated label
104: determination result
105: training use data
106: teaching information
201: machine learning model
202: feature extraction result
203: label generation unit
204: determination unit

1. A machine learning system that evaluates reliability of a prediction result of a machine learning model, the machine learning system comprising:
a machine learning model configured to execute a predetermined task on input data to extract an image feature value from a prediction result and the input data to generate a feature extraction result;
a label generation unit configured to segment the feature extraction result into a plurality of segmented regions based on similarity of the image feature value of the input data to generate a generated label; and
a determination unit configured to evaluate the machine learning model based on an overlap degree between the prediction result and the generated label.

2. The machine learning system according to claim 1, wherein
the determination unit determines a region where the overlap degree is low.

3. The machine learning system according to claim 2, wherein
the label generation unit includes
a division unit configured to divide the feature extraction result into a plurality of divided regions,
a similarity evaluation unit configured to calculate a region feature value indicating a feature of the divided region by using the image feature value and evaluate similarity of each of the plurality of divided regions by using the region feature value, and
an integration unit configured to integrate similar divided regions based on the similarity to generate the segmented region.

4. The machine learning system according to claim 3, wherein
the similarity evaluation unit evaluates similarity between divided regions close to each other.

5. The machine learning system according to claim 4, wherein
when there is no divided region similar to a divided region close to a predetermined divided region, the integration unit sets the predetermined divided region as the segmented region.

6. The machine learning system according to claim 3, wherein
the integration unit integrates the divided regions within a predetermined restriction range.

7. The machine learning system according to claim 3, wherein
the division unit performs division into the divided regions by a super pixel or a neural network.

8. The machine learning system according to claim 7, wherein
the division unit performs division into the divided region by the neural network,
the neural network has a parameter for dividing the input data according to the image feature value, and
the parameter is updated using a division result of division into the divided region, which is calculated from a cost matrix calculated from the image feature value and a cost matrix calculated from a division position.

9. The machine learning system according to claim 2, further comprising:
a teaching unit configured to present, to an operator, a region determined to have a low overlap degree.

10. The machine learning system according to claim 9, further comprising:
a training unit configured to update the machine learning model by using teaching information input by the operator for the region determined to have a low overlap degree.

11. The machine learning system according to claim 10, wherein
the training unit determines necessity of updating the machine learning model, according to the region determined to have a low overlap degree.

12. The machine learning system according to claim 10, wherein
the machine learning model performs reliability evaluation at a time of operation of the machine learning model according to the region determined to have a low overlap degree.
